(19) United States
(12) Patent Application Publication
(10) Pub. No.: US 2002/0090997 A1
(43) Pub. Date: Jul. 11, 2002

(54) System for integrated media presentation

(75) Inventor: Michael Sean Bailey, Los Angeles, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LivePlanet, Santa Monica, CA (US)

(21) Appl. No.: 10/017,468

(22) Filed: Dec. 14, 2001

Related U.S. Application Data
(60) Provisional application No. 60/256,058, filed on Dec. 15, 2000.

(51) Int. Cl. G06F 19/00; G06F 17/00; G06F 15/16

(52) U.S. Cl. 463/42; 463/40; 709/203; 725/37

(57) ABSTRACT

A system for combining media delivery mechanisms such as television and the Internet to provide an entertaining production. In a preferred embodiment, a large-scale “contest” in the form of a bounty hunt uses tens of thousands of registered users, or agents. The agents are assigned to track down, identify and “capture” a single “runner.” The runner is an unknown individual who must elude capture for 30 days to win a money prize. The runner is given goals to achieve throughout the 30 day period. Goals can be to visit a store or restaurant in a specific city, or perform other tasks. Hints about the runner's whereabouts and goals are provided to the agents. Agents score points and can collaborate in groups called “syndicates.” A website provides information in association with televised broadcasts of the contest events. For example, the televised broadcasts include images of the runner in past or current locations. Information about the runner, the runner's past, the runner's acquaintances, etc. Agents and others can appear in the broadcasts to provide the audience with exciting aspects of the overall “hunt.” The website is available to the audience and to agents. Much of the information is public but some is reserved for agent use. The website provides detailed maps, dossier data, profile data, etc. The website provides for exchange of information among syndicate members and can announce events that will be part of the televised programming.

### CROSS-REFERENCE TO RELATED APPLICATIONS

This application claims the benefit of U.S. Provisional Patent Application No. 60/256,058 filed Dec. 15, 2000. This U.S. Provisional Patent Application is herein incorporated by reference in its entirety for all purposes.

### FIELD OF THE INVENTION

Embodiments of the invention relate in general to the delivery of electronic information and more specifically to a system for providing information over a website in association with a television program.

### BACKGROUND OF THE INVENTION

Although the Internet has seen widespread growth and acceptance in the areas of commerce, entertainment, education and research. There is a perception that the Internet has not reached its potential—especially with regard to entertainment. Because of the very limited bandwidth available to almost all users of the Internet, media in the form of full-screen, full-motion video, high fidelity audio, and even rudimentary animations and graphics is often time-consuming and cumbersome for users to access and view.

On the other hand, the Internet has proven itself as invaluable in areas such as keyword searching, providing and obtaining textual information, exchanging electronic mail (email) messages, downloading media files, etc.

Thus, it is desirable to provide a system that successfully combines elements of Internet media delivery with other types of media delivery, such as television programs, to provide improved entertainment, or other applications.

### SUMMARY OF THE INVENTION

One embodiment of the invention is directed to a system for associating digital network-delivered content with television programming, the system comprising: broadcasting a television program regarding a contest in which a user can participate; and providing content over a digital network, wherein the content includes information to assist the user in winning the contest.

Another embodiment of the invention is directed to a method providing an integrated media presentation, the method comprising: providing first information about a media event over a first media distribution mechanism; providing second information about a media event over a second media distribution mechanism, (and optionally providing information via a wireless device such as a cell phone) wherein the second information is associated to the first information; and providing for identifying or capturing a runner using at least one of the media distribution mechanisms.

Another embodiment of the invention is directed to a system comprising: a server computer comprising a website, wherein the website contains information about a runner in a contest; a digital network; a client computer, wherein the client computer communicates with the server computer through the digital network; a television broadcast network; and a television receiving display signals through the television broadcast network and adapted to display images of the runner as the runner attempts to evade capture by one or more agents.

Another embodiment of the invention is directed to a method comprising: providing for a television program that comprises a contest wherein a runner attempts to evade capture by one or more agents; and providing for a website that contains information about the runner.

These and other embodiments of the invention will be described in further detail below in the Detailed Description with reference to the Figures.

### BRIEF DESCRIPTION OF THE DRAWINGS

FIG. 1 illustrates a system according to an embodiment of the invention.

FIG. 2A shows a web page showing a first screen shot of the runner web interface.

FIG. 2B shows a web page showing a national map.

FIG. 2C shows a web page showing a dropdown menu with possible map overlays.

FIG. 2D shows a web page with all overlays turned on.

FIG. 2E shows a web page including a first illustration of dossier information about the runner.

FIG. 2F shows a web page including a second illustration of dossier information about the runner.

FIG. 2G shows a web page including a second illustration of dossier information about the runner.

FIG. 2H shows a web page including a syndicates display.

FIG. 2I shows a web page including a new video window.

FIG. 2J illustrates a web page including a new evidence window.

### DETAILED DESCRIPTION

Embodiments of the invention provide for an entertaining “contest” in the form of a bounty hunt. Aspects of the contest can be broadcast as a television program, which can be in the form of a “reality-based” television program. Unlike scripted television shows, reality based television shows do not have predetermined scripts and actors that recite the predetermined scripts. The public can watch the television show and/or may participate in the contest by contacting a website (or being contacted via a wireless device) that relates to the contest and the television show. An integrated production company can provide content for, and/or maintain, the television program and the website.

In the exemplary contest, agents (off-line or on-line) are assigned to track down, identify and “capture” (e.g., physically and/or virtually) a “runner”. The runner is typically an unknown individual. As used herein, an “unknown” individual refers to a person that is not a public figure or is not generally recognizable by the public at large. In other embodiments, the runner could be a public figure such as celebrity. If the runner is an unknown individual, the runner (and also the off-line agents described below) may achieve celebrity status through the television program, especially if the television program is nationally broadcast. On-line agents, off-line agents, and/or others can appear on the television program or on the website to provide the audience (i.e. including passive users and on-line agents) with exciting aspects of the overall “hunt.”

Any suitable number of runners may be in the contest. For example, there may be one runner in some embodiments. However, in other embodiments, there may be two or more runners per contest. For purposes of illustration, many of the embodiments that are described below refer to a contest with a single runner.

In the contest, the runner evades capture by one or more “agents” for a predetermined period of time and/or performs a predetermined number of tasks within the predetermined time period to win a prize such as a money prize. For example, in one example, during the predetermined period of time, the runner may need to accomplish fifteen tasks within a thirty day period. Exemplary tasks can be to visit a store or restaurant in a specific city, or perform other tasks. Also, in some embodiments, the runner may need to complete a particular task within a given timeframe. For instance, the runner may need to complete 15 tasks in a 30 day period, but may also need to complete 1 task every two days (48 hours) in order to win the prize. In some embodiments, the runner may choose the tasks the runner wants to perform, the mode of travel, and the runner's accommodations. These could alternatively be assigned to the runner.

Preferably, the different tasks to be performed by the runner are performed at different geographic locations. The runner travels to these different locations (i.e., to different cities) to accomplish the tasks. For example, an exemplary list of tasks may include eating at a particular restaurant in St. Louis, Mo., visiting a particular museum in Chicago, Ill., finding and talking to a particular person in New York, N.Y., etc. In some embodiments, certain locations may be more desirable for a runner to visit. For example, a runner might be given more points (resulting in a potentially higher prize) if the runner visits one city over another. For instance, a runner might be given a greater amount of prize money if the runner accomplishes a particular task in San Diego, Calif. as opposed to San Francisco, Calif. The runner can be said to “hit” a location if the runner accomplishes a task at that location.

The number of tasks from which the runner may select may decrease as the contest progresses. By doing so, the contest becomes progressively harder for the runner as the number of places that the runner might be is reduced. For example, the contest may last for about 30 days. On day 1, the runner can chose one task from a list of 50 tasks. On day 10, the list may be reduced to 25 tasks. On day 20, the list may be reduced to 10 tasks.

Because the contest may get more difficult for the runner as the contest proceeds, the runner may be given a larger prize if the runner evades capture for a longer period of time and/or completes a given number of tasks within certain timeframes. For example, the runner may win a prize of $2 million dollars (in year 2001 dollars) if he evades capture for 30 days, but may only win $1 million dollars if he evades capture for 25 days. In another example, the runner may be given $1 million dollars if the runner completes 15 tasks within 30 days, ½ million dollars if 14 tasks are completed in 30 days, or ¼ million dollars if 13 tasks are completed within 30 days, while evading capture during those 30 days. Other prize amounts or scales for awarding prize amounts could be provided in other embodiments.

The runner may be given various resources including money to complete the tasks. In one example, on Day 1, the runner is provided with a predetermined amount of cash to get started. The runner could be given an ATM (automated teller machine) debit card that can allow the runner to access a predetermined amount of money per day. Money not assigned or accessed that day can roll over to the next day. Money withdrawals may be tracked on the website. In some instances, the runner may be required to make purchases at specific merchants during the contest. These merchants may be tied to sponsorship for the television program and/or a website that is associated with the television program.

The parameters of the contest may vary. For example, in one embodiment, the runner may be caught by the agents during a predetermined timeframe (e.g., 8 am-10 pm eastern standard time). The timeframe may be referred to as “running hours”. During running hours, the runner is in plain sight. Outside of the running hours, the runner cannot be caught, nor can the runner hit a location where the task is to be performed.

The runner may be equipped with a tracking device (e.g., GPS or global positioning system device) and surveillance equipment (e.g., a bug). The runner may also be provided with mobile communication devices such as a pager, cell phone, etc. An integrated production company can receive and use data from these devices to validate captures and/or ensure compliance with runner rules. The integrated production company may also provide referees that “shadow” the runner and the offline-agents to make sure that they comply with the contest rules.

In some embodiments, the runner's identity (i.e., name and face) could be kept secret during the initial stages of the contest. Information about the runner such as a personal profile could be disclosed and the runner's name and face could be revealed to the agents and the general public during the course of the contest.

As noted above, in the contest, “agents” try and “capture” the runner before the runner completes all of the tasks. If an agent captures the runner before he completes all of the assigned tasks, the capturing agent can win a reward designated for the agent. The reward may be a monetary reward. The reward may be independent of or dependent on the amount of prize money that the runner is supposed to receive if the runner evades capture.

In some embodiments, there can be two types of agents in the contest, “off-line agents” and “on-line agents”. As will be explained in greater detail below, these different agent types can “capture” the runner in different ways. The different types of agents may also have different rewards available to them. Like the runner, the on-line and the off-line agents could be unknown individuals or public figures (e.g., celebrities).

Off-line agents are individuals that physically chase the runner to capture the runner. These off-line agents can capture the runner in any number of ways. For example, the off-line agents may capture the runner by saying a pre-determined phrase (e.g., such as an apprehension code for the day) to the runner in a face-to-face manner. In other examples, the runner could alternatively be captured by placing both hands on the runner, shining a light on the runner, etc. Preferably, the off-line agent can physically pursue the runner, but does not make or cause physical contact with the runner to capture the runner. This can minimize the potential for physical injury to the runner or the agent. Unlike on-line agents, the off-line agents do not use a client computer to directly capture the runner (although off-line agents may gather information about the runner and the runner's whereabouts from a client computer).

In some embodiments, on-line agents (described in further detail below) may, for example, solve puzzles, perform mental or physical challenges, or may perform other tasks to receive information (e.g., clues) that could help them or an off-line agent capture the runner. For example, puzzles such as code cracking puzzles (e.g., trying to break a code to reveal geographic coordinates) could be provided to one or more on-line agents. The solution to the clue could help capture the runner. Thus, the on-line agents (described in further detail below) may solve puzzles, perform mental or physical challenges, or may perform other tasks to receive information that could help them capture the runner or reveal information that is passed to off-line agents.

In some embodiments, the reward for the off-line agents may increase as the contest progresses. For example, the capturing off-line agent may receive a reward of $25,000 if the agent captures the runner on Day 1 of the contest. In the same contest, the capturing off-line agent may receive a reward of $1 million if the agent captures the runner on the 30^{th} day. Thus, an off-line agent may be more inclined to capture the runner later in the game in order to receive more reward money. However, this may ultimately make it more difficult to catch the runner. For example, as the contest progresses, other off-line agents could capture the runner instead or the runner may become better at evading the pursuing off-line agents.

On-line agents can participate in the contest by contacting a website. The website is available to the audience and to the participating agents. Contact with the website can be made using a client computer. A device such as a personal computer, a PDA (personal digital assistant), or a wireless phone could be used to contact the website. In addition, the website could push information to a PDA or cell phone to help agents capture the runner. Prior to participating in the contest, individuals can register to be on-line agents by supplying appropriate information on the website.

The website provides information in association with televised broadcasts of the contest events. For example, the website may include images of the runner (still or moving) in past or current locations. These images may be images that have been previously broadcast on the television program or may be images that have not been previously broadcast on the television show. Information about the runner, the runner's past, the runner's acquaintances, etc. may on the website. The website also provides detailed maps, dossier data, and profile data, provides for exchange of information among syndicate members, and can announce events that will be part of the televised programming. Much of the information at the website is public but some is reserved for agent use.

On-line agents may also capture the runner by interacting with the website. For example, using a client computer, an on-line agent can visit a website that contains information regarding the contest. The website allows the on-line agents to enter a possible location for the runner. As there may be many on-line agents (e.g., in the thousands), a reward may be provided to the on-line agent that provides the closest location to the runner. The reward for the on-line agent may be different (e.g., by type of reward or by the amount of the reward) than the reward for the off-line agent. In some embodiments, each on-line agent may submit one guess at the runner's location via the website per day or per contest. Thresholds may also be set for rewards given to successful on-line agents. For example, on-line agents with the top 500 guesses (e.g., guesses either the identity or location of the runner) may win some sort of reward.

Off-line agents and/or on-line agents collaborate in groups called “syndicates.” Agents in a syndicate can share information and collaborate in the capture of the runner. If one agent of a particular syndicate captures the runner, all members of the syndicate may share in the reward. The website may permit on-line agents in a syndicate to communicate with each other.

The syndicates may be public syndicates or private syndicates. Public syndicates may be started by the integrated production company. On-line agents may join the public syndicate and the integrated production company may set any suitable rules for splitting any reward won by a syndicate. If a member of a public syndicate captures a runner, the capturing agent can receive 50% of the reward and the rest of the syndicate splits the remaining 50%.

Private syndicates may also be used in the contest. Private syndicates may be started by an on-line or off-line agent. The agent that creates the syndicate may be the leader and has administrative authority over the private syndicate. The members of the private syndicate may decide on their own how to share in the reward.

Any suitable parameters may be used to determine what type of reward and/or how much reward agents will get if they capture the runner. Factors that can be used to determine rewards may include, for example, the agent's time online, the number of capture guesses submitted, the proximity of the capture guesses to the actual location of the runner, the agent's participation or non-participation in a syndicate, the agent's participation at sponsor sites, time in chat rooms on the website, participation in quizzes provided on the website, leadership in a syndicate, etc.

In addition to the runner, the on-line agents, and the off-line agents, there may also be passive users. Passive users are individuals that do not actively participate in the contest and try and capture the runner. Typically, the passive users are members of the general public that are entertained by the contest by watching the television program and/or by interacting with the website associated with the contest.

Some additional rules in the contest might be that the runner or the agents may not break any laws (local, national, etc.), leave the country that they are in, and/or pre-arrange for the runner's capture. Agents or runners could be subject to disqualification if these or other rules are broken.

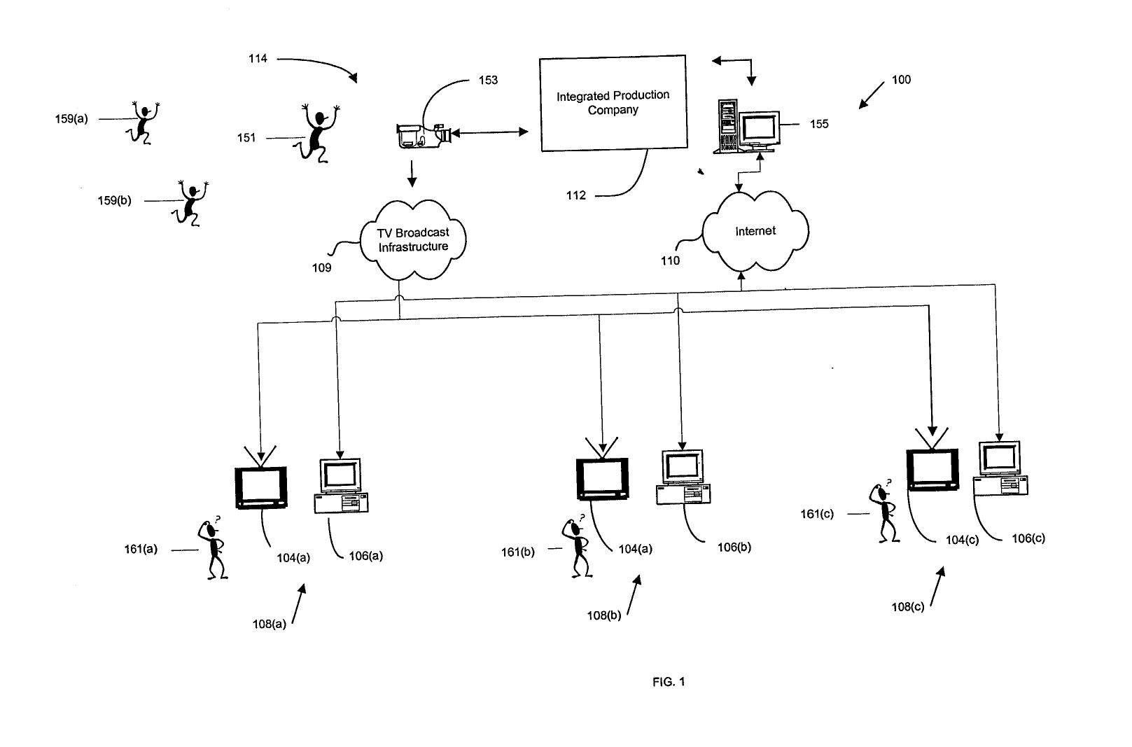

FIG. 1 illustrates system 100 according to an embodiment of the invention. The system 100 may include a plurality of on-line agent locations 108(a)-108(c). Each on-line agent location 108(a)-108(c) may include a television set 104(a)-104(c), a client computer 106(a)-106(c), and an on-line agent 161(a)-161(c).

A server computer 155 can be at a remote location (i.e., a location that is remote with respect to the on-line agent locations 108(a)-108(c)). The server computer 155 may contain the website that the on-line agents 161(a)-161(b) use to participate in the contest. Other characteristics of the website are provided above and below. Other persons such as passive users may also visit the website on the server computer 155.

The server computer 155 and the client computers 106(a)-106(c) communicate through the Internet 110, and more particularly the World Wide Web (WWW). Other suitable digital networks may also be used to facilitate communication between the server computer 155 and the client computers 106(a)-106(c). The digital network may contain wireless or wired links. Typical communication protocols that can be used by the server computer 155, and the client computers 106(a)-106(c) may include HTTP (hypertext transfer protocol), TCP/IP (terminal communication protocol/Internet protocol), or other protocol.

The server computer 155 is typically a powerful computer or cluster of computers. For example, the server computer can be a large mainframe, a minicomputer cluster, or a group of servers functioning as a unit. In one example, the server computer may be a database server coupled to a Web server. The server computer can behave as a single computer that services the requests of one or more client computers. For example, one or more client computers 106(a)-106(b) at the different agent locations 108(a)-108(b) can communicate with the server computer 100 through the Internet 110 and optionally through one or more Internet Service Providers (ISPs) (not shown).

In general, the client computers 106(a)-106(c) typically have less memory and less computing power than the server computer 155. The client computers 106(a)-106(c) may be any suitable device that can receive information from and send information to the server computer 155. For example, the client computers 106(a)-106(c) may include personal computers, workstations, cell phones, PDAs (personal digital assistants), etc.

The server computer 155 can have computer code for performing any suitable function. For example, the server computer 155 can have code for operating the website, code for playing video or still images of the runner 151, off-line agents 159(a)-159(b), or action from a televised action event 114. In another example, code for operating a chatroom, instant messaging center, or other communication means for on-line agents, as well as code for providing maps of the runner's path of travel and potential targets can be provided on the server computer 155. Specific details about the specific functions performed by the website are provided below. The creation and maintenance of websites in general is well known to those of ordinary skill in the art.

A production crew 153 can film the televised action event 114 using one or more cameras. The production crew 153 can be responsible for capturing the televised action event 114 on video. The televised action event 114 may be, or form part of, a media event. The televised action event 114 can include a runner 151 that is being physically pursued by one or more off-line agents 159(a)-159(b). The production crew 153 can follow the runner 153 and the off-line agents 159(a)-159(b) as the runner 153 tries to evade the off-line agents 159(a)-159(b). Preferably, the televised action event is unscripted.

The televised action event 114 may be taped and then transmitted through a television broadcast infrastructure 109 to the televisions 104(a)-104(c) at the various on-line agent locations 108(a)-108(c). Alternatively, the televised action event 114 may be transmitted live to the televisions 104(a)-104(c) through the television broadcast infrastructure 109.

The television broadcast infrastructure 109 may comprise one or more of, for example, a cable TV network and/or a satellite dish network (or other antenna television broadcast network). Wireless or wired communication links may be used to transmit television signals through the television broadcast infrastructure 109.

An integrated production company 112 may operate both the production crew 153 and the server computer 155 containing the website. The integrated production company 112 could be, for example, one or more corporate entities that supply content for the website on the server computer 155 and controls the production crew 153.

In FIG. 1, the on-line agents 161(a)-161(c) are presented with information from two different electronic media distribution mechanisms such as traditional television broadcast infrastructure 108 and the Internet 110. Passive users (not shown) who do not actively participate in the contest, but use the client computers 106(a)-106(c) and/or the televisions 104(a)-104(c) could also be entertained by the contest through the two different media distribution mechanisms.

TV broadcast infrastructure 108 is used to acquire signals generated by televised action event 114. The signals are then sent to the user's television 104 through the TV broadcast infrastructure 108. The Internet 110 is used to send and receive information from integrated production company's 112 facilities and to allow Internet users, such as the on-line agents 161(a)-161(c) to send and receive information, or otherwise interact with information provided by the integrated production company 112.

The integrated production company 112 can also be in communication with the televised action event 114, the TV broadcast infrastructure 114, and any information resources (not shown) provided by the Internet 110. This allows the integrated production company 112 to selectively provide video feeds of the televised action 114 onto the Internet 110 and obtain still images from the televised action event 114 for use on the Internet 110. The integrated production company 112 can also make use of the ability of the Internet 110 to handle text, numbers, audio and user interaction, in order to facilitate an integrated production, as discussed.

Embodiments of the invention have a number of advantages. For example, public attention is generated by both the television program and public access to the website. The television program and website, in turn, can act to steer attention to each other and can provide related information in different forms that can serve as clues to the agents, and public at large. Because two different media distribution mechanisms or modes of distribution can be used in embodiments of the invention, the public (including the on-line agents and passive users) can entertained and engaged with the contest for longer periods of time (e.g., not just during the time when the television program is broadcast). Advertisers can advertise on either or both the website or the television program, thus generating wider distribution for advertising to a wider audience while using a single contest. The potential audience for the contest is large and includes persons who are garners, television viewers, web surfers, reality show enthusiasts, etc.

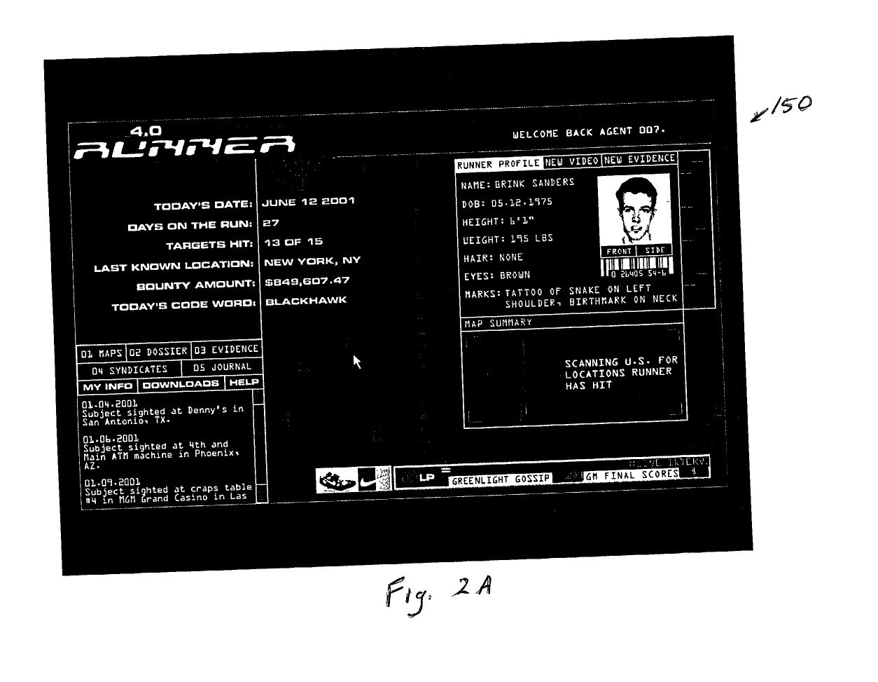

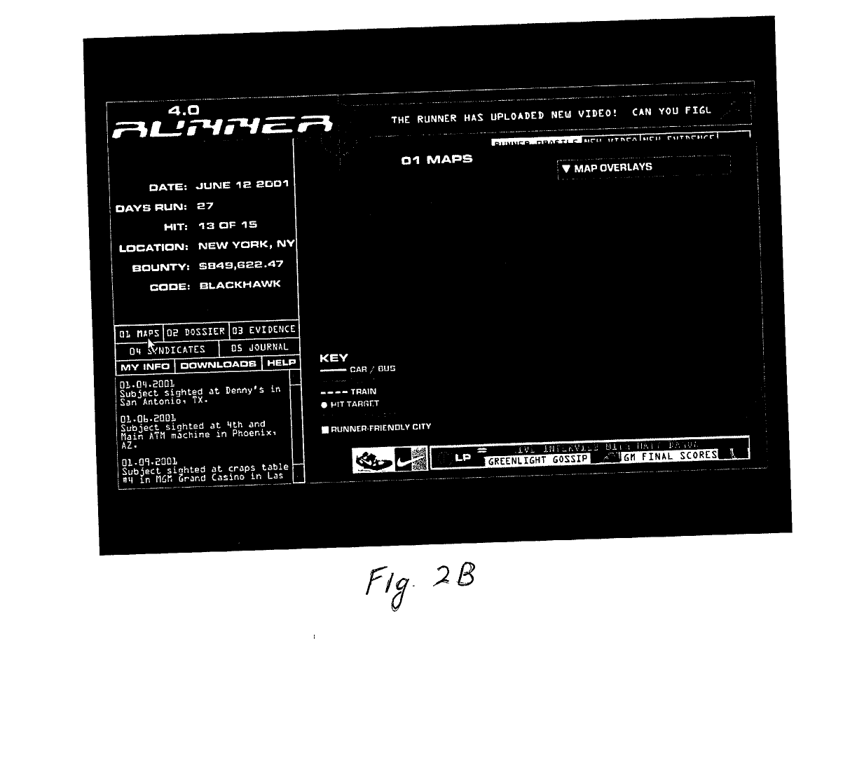

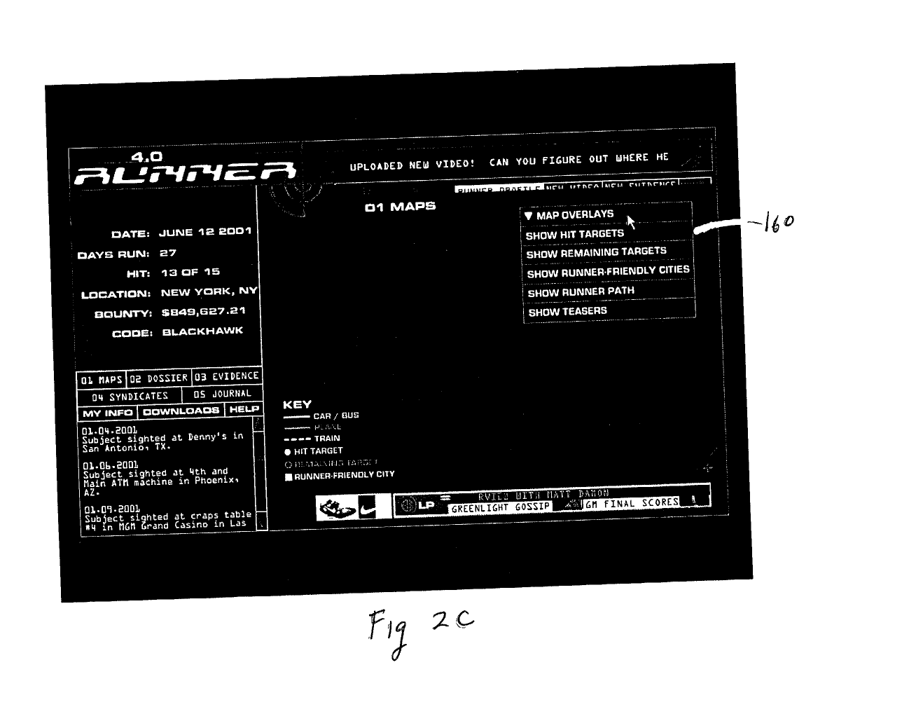

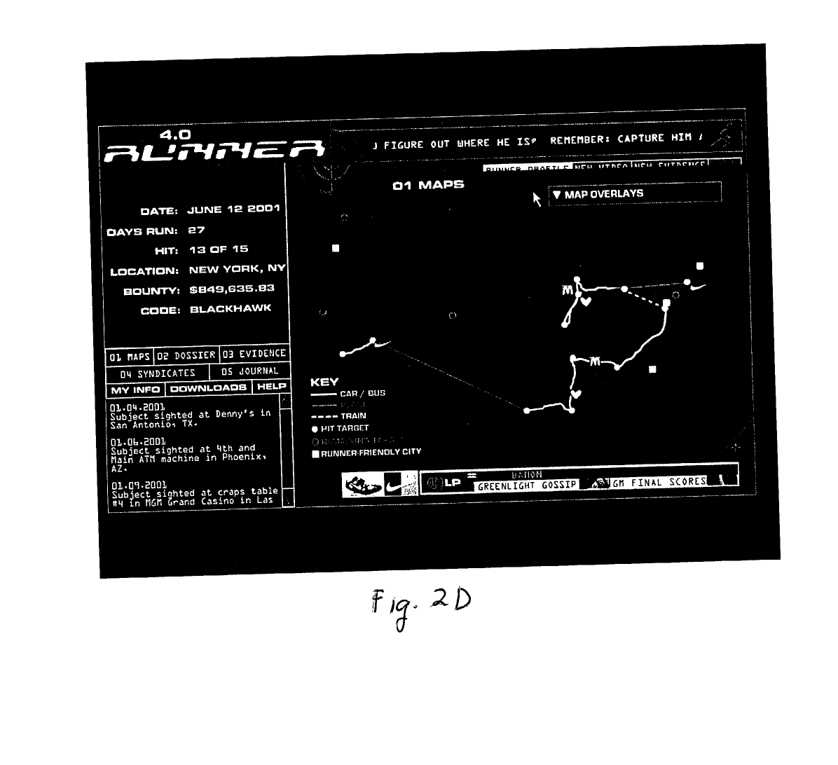

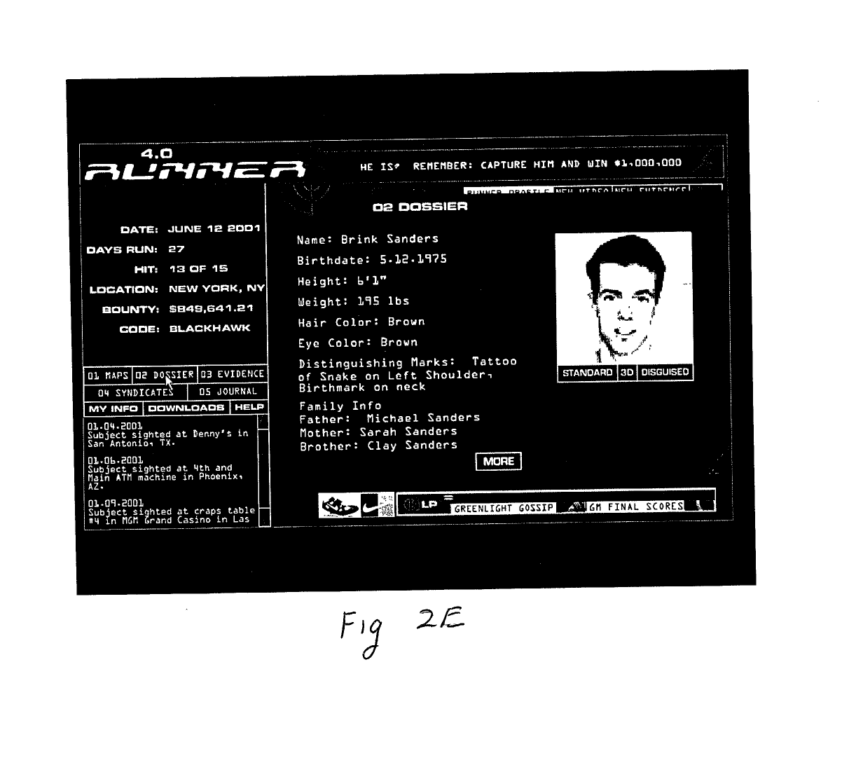

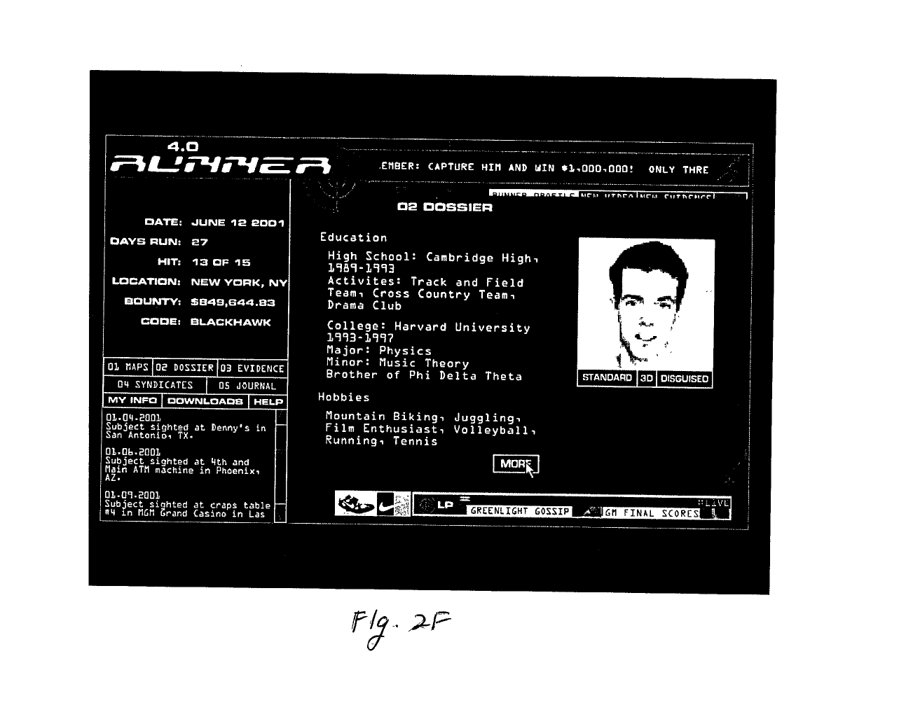

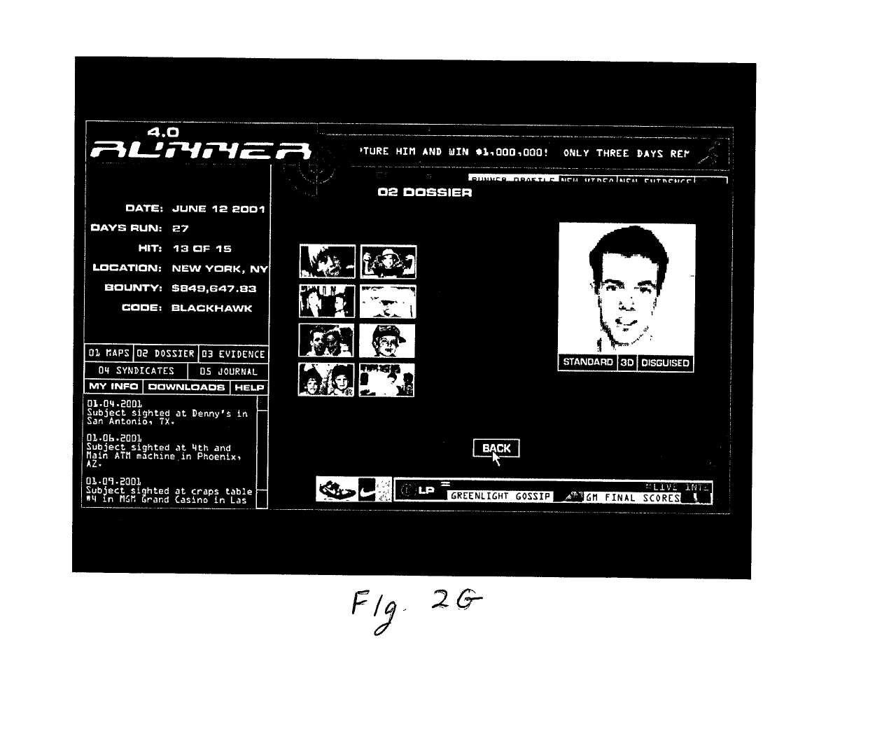

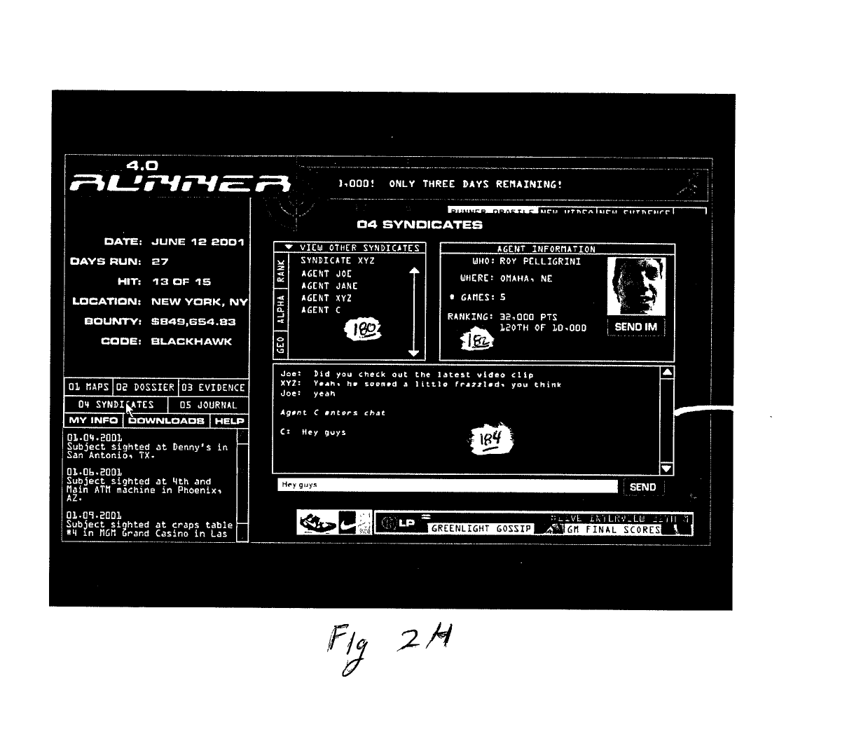

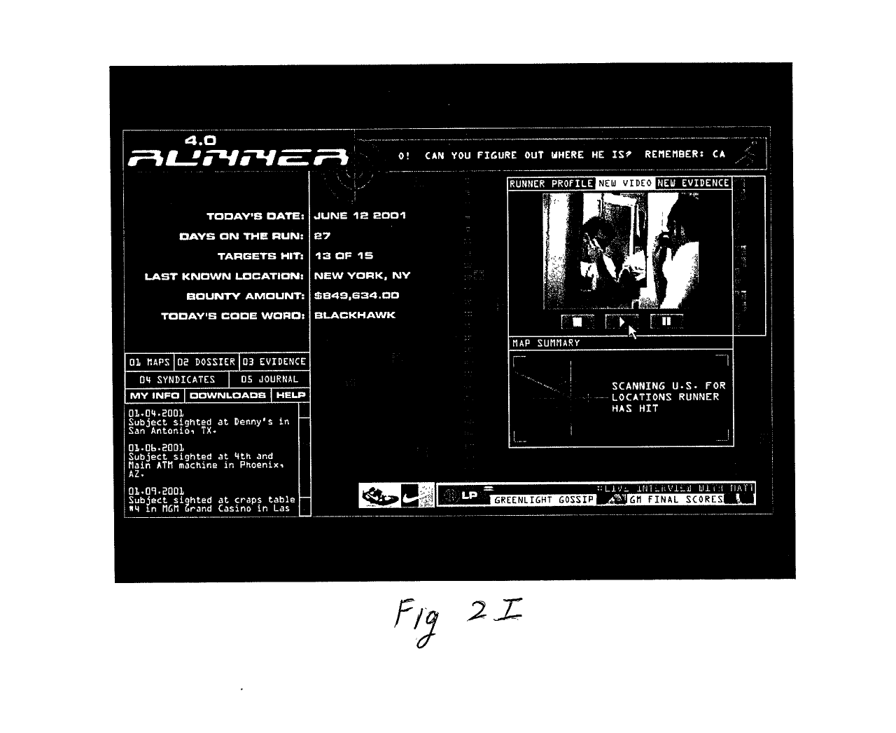

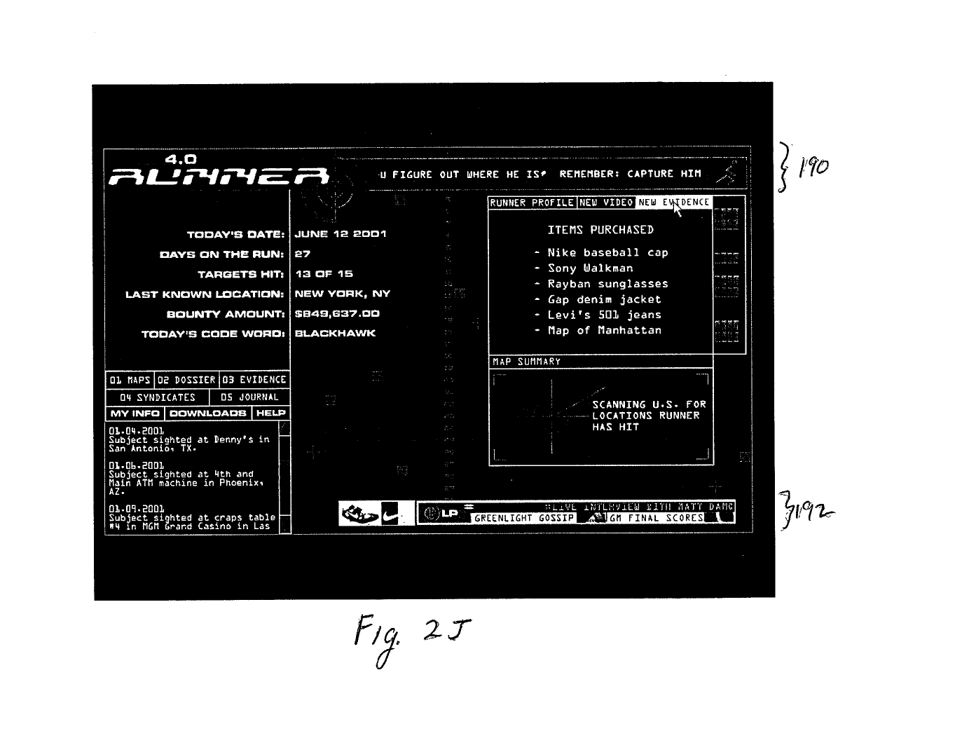

FIGS. 2A to 2J show various web pages that may be present on the website that is associated with the contest.

FIG. 2A illustrates a web page showing a runner profile and picture of the runner. In FIG. 2A, many of the areas of display 150 are active, or selectable, by a user, for example, by clicking on the area with a mouse and pointer. Text such as “01 MAPS,” “02 DOSSIER,” “03 EVIDENCE,” “04 SYNDICATES,” “05 JOURNAL,” “RUNNER PROFILE,” “NEW VIDEO,” “NEW EVIDENCE,” “GREENLIGHT GOSSIP,” AND “GM FINAL SCORES” are links to additional displays, pages, windows or other means of presenting information as is known in the art. Other selectable links include “MY INFO”, “DOWNLOADS”, and “HELP”. Underneath these selectable links is a scrollable list of dates and places where the runner was sighted.

FIG. 2A and other figures show basic information on the status of the contest. For example, the current date, the number of days on the run, the number of targets hit, and the current reward amount (i.e., “bounty” amount) are displayed. Also, the code word for the day (e.g., “blackhawk”) is also displayed. An off-line agent can say the codeword of the day to the runner to capture the runner.

Information about the runner including the runner's name, date or birth, height, weight, hair, eye color and distinctive marks can also be displayed. This information can be useful in identifying the runner if, for example, the runner is disguised. Advertisers may also advertise on this or other web pages.

After selecting the “MAPS” link in FIG. 2A, a web page like the one shown in FIG. 2B may be presented. FIG. 2B shows the national map and symbol legend. Map overlays are available by selecting the “MAP OVERLAYS” bar. Selecting this bar activates a drop-down window with possible map overlays. The possible overlays are shown in window 160 of FIG. 2C. In this example, the overlays are “SHOW HIT TARGETS,” “SHOW REMAINING TARGETS,” “SHOW RUNNER-FRIENDLY CITIES,” “SHOW RUNNER PATH” and “SHOW TEASERS.” Each type of overlay can be selectively turned on or off for display on the national map. Once an overlay is turned on, the corresponding entry in window 160 changes to indicate a selection to turn the overlay off. For example, clicking on “SHOW HIT TARGETS” brings up the “hit target” symbols on the map and changes the entry in window 160 to “HIDE HIT TARGETS.”

FIG. 2D illustrates the map with all overlays turned on. Thus, a user such as an on-line agent is able to obtain information about the runner's past performance which could lead to clues about future actions and capture. For example, the runner's course is plotted in a color-coded and symbolic manner that indicates mode of transportation. Targets that the runner has hit are shown, as are the remaining targets. This information gives the agent clues about where the runner may be, where the runner is likely to go, and where the runner will probably not go (since the runner has been there already).

Runner-friendly cities are also shown. Runner friendly cities are a city where the runner has lived, went to school, or has relatives or good friends. They imply that the runner may have an easier time in locations (targets) in or near cities that are familiar to the runner. This can be an indication to an agent that the runner may try to achieve objectives in the runner-friendly cities since the runner is more familiar with those cities.

“Teaser” cities are also shown. Teaser cities (or objective locations) are locations where the runner has extra incentive to visit because of auxiliary prizes, money, or advantages that the runner can obtain. For example, a teaser city may have a sponsor restaurant offer to add to the runner's prize money if the runner can obtain a meal in the particular restaurant. Using the combination of information provided by the national map and overlays, an agent can formulate educated guesses or perform a sophisticated analysis of the runner's likely whereabouts. For example, if there is a teaser location in a runner-friendly city then there may be a higher likelihood that the runner will visit the location.

In FIG. 2D, the runner's path of travel is plotted. Each mode of transportation that the runner has previously used is also plotted. For example, the runner's use of a car/bus, plane, or train is plotted on the map.

FIGS. 2E-G illustrate dossier information about the runner.

The web page in FIG. 2E may be shown after the user selects the “DOSSIER” link shown in, for example, the web page shown in FIG. 2A. Additional information about the runner may be obtained by selecting the “MORE” button located on the bottom half of the web page. The dossier window shows basic information on the runner such as age, height, weight, etc., as shown in the Figs. Naturally, some information can be omitted and other information can be added. For example, the runner's facial image can be obscured. Note there are options for showing the runner in “STANDARD,” “3D” and “DISGUISED” versions. Since the runner will typically be disguised during the 30-day contest, the DISGUISED option allows a user/agent to simulate different disguises on the runner's image. A preferred embodiment of the invention will also allow a computer model of the runner to be displayed and manipulated (e.g., rotated, scaled, add a beard, change color/length of the hair, etc.) so that the user can view the runner's image, or modified image, from different angles and simulated distances. In FIG. 2E, the runner's image is shown in the STANDARD view—which is undisguised and only two-dimensional. Software for performing such image manipulations is well known.

FIG. 2F shows additional information available in the dossier display. In this example, the additional information relates to the runner's education and hobbies.

FIG. 2G shows images of older pictures of the runner and family or acquaintances of the runner. Note that the information in the dossier can be provided from the production company or from other sources. The production company can provide the information (or any information presented in the web interface) at the outset of the contest or from time-to-time as the contest progresses. Every agent need not have the same information. Agents may obtain information by themselves and post, email or otherwise trade the information on the runner. Information can be posted on public message boards or within private syndicate message boards.

FIG. 2H illustrates a web page with a syndicates display. This web page can be displayed after selecting the “SYNDICATES” link shown in, for example, FIG. 2A.

In FIG. 2H, an agent is presented with information available to the agent's syndicate. As noted above, a syndicate is a collection of agents. The syndicate can be formed voluntarily by each agent asking for, and receiving, membership. A syndicate can also be formed by assignment by a third party (e.g., the production company), or by other means. Syndicate members are shown in box 180. Other syndicates can be selected to view the selected syndicate's members.

An on-line agent can use the interface to join a syndicate. When choosing to join a syndicate, the agent clicks on a syndicate name to obtain more information. Characteristics of the syndicate such as the location of syndicate members (geography), how long the members have played the game, how many points the members have, etc. Thus, agents are able to get basic information about a syndicate before attempting to join. Information on agents can be found in agent window 182. Each syndicate's agent can correspond in chat area 184 with other agents in the syndicate.

Note that agent information in window 182 includes the rank of the agent (e.g., as 120th out of 10,000) and the agent's current score (of 32,000 points). In a preferred embodiment, agents can gain points in a number of ways. Agents gain points by simply logging onto the website each day. Agents can also gain points by answering trivia questions, questions about the location of the runner, and by other means. Points can be used to rank agents for prize giveaways, chances to win prestige, etc. An agent with a high point total might be asked to come on the television show to talk about how they are so good at tracking. The points also might give prestige to the agents. For example, agent names can be displayed in a ranking list, a star or other symbol can be placed by the agent's name, etc.

FIG. 2I illustrates a “New Video” window. In FIG. 21, a video window is available with standard video control keys to allow a user to view selected video posted to the website hosting the Runner web interface. The video can give clues to the user as a tie-in to the televised event. In the video shown in FIG. 21, the runner is removing a disguise. Audio of the runner's voice is also provided as additional clues, not only in the character of the runner's voice, but in what might be conveyed by the runner's speech. The video can be paused, played repeatedly, etc., as desired by the on-line agent. The video may or may not have appeared or appear on the television show.

FIG. 2J shows the “New Evidence” window. In FIG. 2J, new evidence is posted by the production company to give additional hints and clues for the contest. The text in FIG. 2J shows items that the runner has recently purchased. This can give the on-line agents and the off-line agents clues about what the runner looks like, where the runner has recently been, and what future actions the runner may take.

The interface provides additional areas of information. Such areas can be related to the contest or can be used for advertising or other purposes. In FIG. 2J, scrolling banner 190 at the top of the screen is used to display enticing messages to encourage users to participate. Area 192 is used to display sponsors' advertising icons, to exchange gossip, provide scores, provide updated information, provide latest news and other information, and to announce associated programming such as televised interviews, Internet events (e.g., live chat), etc.

Although the present invention has been discussed with respect to specific embodiments, these embodiments are merely illustrative, and not restrictive, of the invention. For example, although the invention is discussed with respect to specific types of media distribution such as television broadcasts and the Internet, any type of electronic information distribution can be used. One possibility is that the telephone system can be used to provide electronic information in the form of voice, text, data, etc. Also, a cable television network can be used to convey video, audio, text, images, or other types of data. It is possible that the distribution mechanisms can be integrated, or partially integrated, as where a television is web-enabled so that information from a digital network, such as the Internet, is displayed along side of, or using the same device, as a television signal.

What is claimed is:

1. A method for providing integrated media presentation, the method comprising
broadcasting a television program regarding a contest in which an agent can participate; and
providing content over a digital network, wherein the content includes information to assist the agent in winning the contest.

2. The method of claim 1, wherein the contest includes determining the identity of a person.

3. The method of claim 1, wherein the contest includes contacting a person.

4. The method of claim 1, wherein the contest includes capturing a person.

5. A method providing an integrated media presentation, the method comprising
providing first information about a media event over a first media distribution mechanism;
providing second information about a media event over a second media distribution mechanism, wherein the second information is associated to the first information; and
providing for identifying or capturing a runner using at least one of the media distribution mechanisms.

6. The method of claim 5, wherein the first media distribution mechanism includes a television broadcast and wherein the second media distribution mechanism includes the Internet.

7. A system comprising:
a server computer comprising a website, wherein the website contains information about a runner in a contest;
a digital network;
a client computer, wherein the client computer communicates with the server computer through the digital network;
a television broadcast network; and
a television receiving display signals through the television broadcast network and adapted to display images of the runner as the runner attempts to evade capture by one or more agents.

8. The system of claim 7 wherein the digital network is the Internet.

9. The system of claim 7 wherein the website contains maps of the runners path of travel.

10. The system of claim 7 wherein the website contains hints about the runner's location.

11. The system of claim 7 wherein the website contains a page for allowing online agents to share information about the runner's location and a page for allowing the online agents to enter a location for the runner.

12. A method comprising:
providing for a television program that comprises a contest wherein a runner attempts to evade capture by one or more agents; and
providing for a website that contains information about the runner.

13. The method of claim 12 wherein the agents are offline agents, and wherein the method further comprises:
providing, through the website, for the ability of an online agent to attempt to capture the runner by entering a location for the runner.

14. The method of claim 12 wherein, in the contest, the runner wins a larger prize if the runner evades capture for a longer period of time.

15. The method of claim 12 wherein, in the contest, the runner wins a prize if the runner completes a predetermined number of tasks within a predetermined time.

16. The method of claim 12 wherein, in the contest, the runner wins a prize if the runner completes a predetermined number of tasks within a predetermined time, and wherein the one or more agents win a reward if the one or more agents capture the runner before the runner completes the predetermined number of tasks.

17. The method of claim 12 wherein the information about the runner comprises clues regarding the runner's current location.

18. The method of claim 12 wherein, in the contest, the runner completes a predetermined number of tasks within a predetermined period of time, wherein each task is to be performed at a different geographic location, and wherein the information about the runner on the website includes information about the tasks completed by the runner.

19. The method of claim 12 further comprising:
providing clues about the runner's location or identify to the at least one agent if the at least one agent solves a puzzle.
